(19) United States
(12) Patent Application Publication
(10) Pub. No.: US 2013/0059937 A1
(43) Pub. Date: Mar. 7, 2013

(54) SUPER-SOFT THERMOPLASTIC ELASTOMERS

(71) Applicants: Santosh Bawiskar, Crystal Lake, IL (US); Gerald W. Meyer, Crystal Lake, IL (US)

(72) Inventors: Santosh Bawiskar, Crystal Lake, IL (US); Gerald W. Meyer, Crystal Lake, IL (US)

(73) Assignee: POLYONE CORPORATION, Avon Lake, OH (US)

(21) Appl. No.: 13/695,995

(22) PCT Filed: May 5, 2011
(86) PCT No.: PCT/US2011/035409

§ 371 Date: Nov. 2, 2012

Related U.S. Application Data
(60) Provisional application No. 61/331,449, filed on May 5, 2010.

(51) Int. Cl. C08L 25/08; B29C 39/00; C08L 25/10

(52) U.S. Cl. 521/148; 524/575; 524/578; 521/146; 264/299

(57) ABSTRACT

A thermoplastic elastomer (TPE) compound is disclosed which has very low hardness by virtue of the use of a combination of porous styrene block copolymer thermoplastic elastomer of a molecular weight greater than 200,000 and plasticizer oil of a molecular weight less than 400 present in an amount between 85 and 91 weight percent. Super-soft extruded or molded plastic articles can be formed from pellets of the compound, with a resulting Shore OOO Hardness of between 45 and 60. Molded articles can be prepared using hot melt adhesive dispensing units.

### CLAIMS OF PRIORITY

This application claims priority from both U.S. Provisional Patent Application Ser. No. 61/331,449 bearing Attorney Docket Number 12010011 and filed on May 5, 2010 and U.S. Provisional Patent Application Ser. No. 61/437,342 bearing Attorney Docket Number 12011002 and filed on Jan. 28, 2011, both of which are incorporated by reference.

### FIELD OF THE INVENTION

This invention relates to thermoplastic elastomers, polymer compounds which exhibit elasticity while remaining thermoplastic, which also have very low hardness values and are in pellet form.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

Thermoplastic elastomers (TPEs) combine the benefits of elastomeric properties of thermoset polymers, such as vulcanized rubber, with the processing properties of thermoplastic polymers.

Traditionally, soft TPE compounds have been made in a kettle in batch processes and subsequently packaged in drums or subjected to underwater pelletization. Batch processing has a long cycle time (˜3 hrs or more) and also has the difficulty in homogenizing the mixed ingredients due to low shear of mixing blades in the kettle, yellowing of the mixed ingredients due to oxidation (unless nitrogen or carbon dioxide blanketing is used), and contamination due to difficulty in cleaning such kettles and associated piping.

On the other hand, if twin screw extruders and other high shear mixers (such as Farrel brand continuous mixers, Buss brand co-kneaders) could be used to mix these soft TPE compounds, the mixing would be continuous, happen in a short time, produce a homogeneous mixture, and also provide a non-yellow, non-contaminated finished product resulting in low manufacturing costs.

The current drawback of twin screw extruders and other high shear mixing equipment is that they cannot handle large levels of oils, such as greater than 84 weight percent, inherently present in soft TPE compounds, because above a certain weight percent of oil, there is slippage of ingredients within the extruder. Homogeneity of the mixture cannot be achieved.

Special screw design using special mixing elements have been attempted; injecting oil at various locations in the extruder downstream of the throat of the extruder has also been attempted.

Currently, soft TPE compound remains being made in a batch process first discussed.

### SUMMARY OF THE INVENTION

What the art needs is a new way to make soft TPE compounds in pellet form which is economical and continuous, resulting in homogenous TPE compounds suitable for later molding, extruding, calendering, or other reshaping event to form the final plastic article.

The present invention solves the problem by determining a combination of TPE and plasticizer oil with properties sufficient to enable compounding of those ingredients to form very soft TPE compounds ready in pellet form for further processing into the final plastic article.

One aspect of the invention is a low hardness thermoplastic elastomer compound, comprising (a) a styrene-containing thermoplastic elastomer having a weight average molecular weight of greater than 200,000 and an oil absorption time of less than 900 seconds, and (b) plasticizer oil having a weight average molecular weight of less than 400 absorbed into the styrene-containing thermoplastic elastomer in a weight percent of the compound ranging from 85 to 91.

Another aspect of the invention is a low hardness plastic article reshaped from the TPE compound.

Features of the invention will become apparent with reference to the following embodiments.

### EMBODIMENTS OF THE INVENTION

Styrenic block co-polymers (SBCs) and paraffinic/white mineral plasticizer oils are of great interest to make very soft TPE compounds. SBCs are compatible with such oils, and compositions with greater than 85% oil are now possible in the present invention, yielding gels with Shore OO hardness of 25 Shore OO or less, which do not bleed oil in end-use applications in a temperature range of from 45° F. to 110° F.

The compatibility of the SBC and the oil results from the chemical nature of the midblock of the SBC which is very similar to the chemical nature of the white mineral oil. The lower the molecular weight of the oil, the better the compatibility.

A further attribute of some SBCs is that they are available in “crumb” form, a form which is very porous (much like a sponge), such that the crumb can physically absorb large amounts of plasticizer oil and still seem dry or non-slippery to human touch after mixing in a high intensity mixer (e.g., a Henschel brand mixer).

The capacity of SBC crumb to absorb oil is important to the present invention, because the oiled crumb can be easily conveyed and fed into the high shear mixers discussed above and subsequently homogenized (at a molecular level), and then pelletized as like any other extruded product. The economies of continuous extrusion can be employed. The pellet form of the soft TPE compound is much preferred over packaging in a drum or carton or other similar packaging.

If the crumb morphology and the oil viscosity are not matched well, either an oily (“wet”) crumb will result or the mixing time required to fully absorb the oil and achieve dryness will be longer than economically practical. In either case the process will then be less efficient. However in most cases, above about 80% weight percent oil, as crumb gets saturated with oil, the potential result is an oily crumb which is incapable of being fed into an extruder throat for the compounding process to yield pelletized TPE compound.

Thus, for the present invention, both the compound formulation and its process steps of mixing are significant. Above a certain weight percent of oil in the compound, even the most acceptably porous crumb gets saturated with oil and can no longer be handled and fed into the extruder.

In some extreme cases, although the oiled crumb can be fed into the extruder, slippage within the extruder occurs, resulting in less than homogenous compound.

The present invention overcomes these issues. By using a very low molecular weight oil (less than 400 M_{w}, desirably less than 300 M_{w}, and preferably less than 275 M_{w}) in combination with a high molecular weight styrenic block copolymer (SBC) (more than 120,000 M_{w}, desirably more than 150,000 M_{w}, and preferably more than 200,000 M_{w}), the TPE compound has a chance of being dry to human touch after Henschel mixing and being extruded and pelletized in homogenously mixed pellets having a plasticizer oil loading of more than 85 weight percent to form a TPE compound having a Shore OOO Hardness of less than about 60.

It has been found that the porosity of the crumb provides the final factor matching SBC polymer with oil to make the pellets of the present invention. Measuring porosity of the SBC crumb is very difficult. Manufacturers of the SBC polymer might know but do not publish such information. A Brabender mixer can be used to evaluate the porosity and oil absorption characteristics of a SBC crumb. This is done by adding oil to the crumb in the mixer and monitoring the torque. A step change in the torque implies onset of complete oil absorption. The more porous the crumb the better. The faster absorption of oil into the crumb the better. Taking into consideration the chemistry of the SBC polymer, the chemistry of the plasticizer oil, and the physical porosity of the SBC crumb, less than 900 seconds before change in torque is needed for any acceptability of the SBC polymer in the present invention. Desirably, the duration to torque change is less than 750 seconds. Preferably, the duration to torque change is less than 600 seconds. For purposes of this invention, that time duration to change in torque will be called “Oil Absorption Time” or “Apparent Porosity.”

While Oil Absorption Time is a quantitative time measurement indicating Apparent Porosity, a person having ordinary skill in the art without undue experimentation can make a qualitative correlation to that quantitative measurement in order to provide a preliminary determination whether a particular SBC crumb has sufficient porosity.

After the mixing of oil into the crumb within the Henschel mixer and the passage of 24 hours, a person having ordinary skill in the art will be able without undue experimentation to determine by hand touch whether the SBC crumb retains an oily outer surface, making it “wet” or slippery to the touch of a human hand. Conversely, that same person will be able to determine the oiled crumb condition to be “dry” or not slippery to the touch of a human hand.

Moreover, the oiled crumb will itself demonstrate whether it can be fed into the throat of a twin screw extruder, with or without “cramming.” If the oiled crumb is too wet, it is not suitable for extrusion into pellets. Even if the oiled crumb is dry enough, the feeding of the oiled crumb into the extruder typically involves “cramming”, which is a term meaning the oiled crumb has to be mechanically forced into the extruder. A device such as a Crammer feeder is suitable to do this but in the experiments described this was done manually with a plastic rod.

The well-mixed TPE compound emerges from the extruder into a conventional underwater pelletizer to cut the feedstream into pellets of about 2-6 mm in length or between 20 to 80 pellets per gram. Using the formulation and the processing described, the resultant pellets can be non-yellow and free of any black specs. In other words, a marketable very soft TPE compound can be sold in the form of pellets to make plastic articles economically.

The soft pellets of the TPE compound can be dusted with a partitioning agent such as talc, polyolefin wax, metal stearate, silica, starch or other mineral fillers in an amount of between 500 and 10,000 ppm (0.05% to 1% by weight) of the compound. The partitioning agent can have a particle size ranging from about 100 nm to 30 μm. The partitioning agent keeps the soft pellets free from blocking during storage before use.

It has been found that oil loading even into an acceptably porous SBC crumb has a relatively narrow window, about 84—about 88 weight percent of the compound. Even though this range has not been previously reached, especially in the form of pellets, there is a desire to increase oil loading.

The amount of oil loading into the SBC polymer can be increased by oil injection into the extruder after first mixing section and could be at any location as long as the additional oil that is injected can be incorporated into the melt of SBC polymer. The oil can be injected using a gear pump that pumps it through an oil injection nozzle into the barrel of the extruder with the pump having gravimetric controls. It has been found that this oil injection option can increase the oil loading up to 91% oil by weight and still achieve a very soft TPE compound in pellet form.

SBC Copolymer

TPEs of the present invention are based on SBC copolymer, which are conventionally compounded with plasticizer, antioxidant, thermal stabilizer, and one or more secondary polymers. Any SBC copolymer which has a block compatible with plasticizer oil used in the invention is a candidate for use in this invention.

Non-limiting examples of SBC copolymer include styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, and combinations thereof. These examples of SBC copolymer may or may not be maleated. They have weight average molecular weights in excess of 150,000 and preferably in excess of 200,000. Of possible SBC copolymer candidates, styrene-ethylene-butylene-styrene (SEBS) is particularly useful because the olefinic mid-block is capable of holding large amounts of plasticizing oil. So is styrene-ethylene-ethylene/propylene-styrene (SEEPS).

If a candidate SBC copolymer fuses during Henschel mixing, then it can not be used in the invention.

Commercially available grades of these SBC copolymers are made by Kraton Polymers (Houston, Tex., USA) and marketed using the Kraton brand. Of the preferred SEBS, those presently preferred grades are Kraton G1654H (a linear triblock copolymer based on styrene and ethylene/butylene with a polystyrene content between 29.5 and 32.5, a specific gravity of 0.92, and a Shore A hardness of 63) and Kraton G1651HU (a clear, linear triblock copolymer based on styrene and ethylene/butylene with a polystyrene content of 33%, a specific gravity of 0.91, and a Shore A hardness of 60). Of the commercially available SEEPS, Septon brand 4077 SEEPS from Kuraray America, Inc. is also useful.

As described above, the SBC copolymer needs to have an Apparent Porosity of less than 900 seconds, desirably less than 750 seconds, and preferably less than 600 seconds.

Plasticizer Oil

Any conventional plasticizer, preferably a paraffinic oil, is suitable for use the present invention, if it has a weight average molecular weight of less than about less than 400 M_{w}, desirably less than 300 M_{w}, and preferably less than 275 M_{w}.

The oil can be sufficiently low in molecular weight to be quickly absorbed by the SBC crumb during high speed mixing and to be sufficiently compatible with the SBC copolymer for mixing, extruding, pelletizing, and reshaping into the ultimate plastic article in its end-use application.

The oil preferably has a relatively high flash point, typically above 220° F. but often above 270° F., in order for the oil to be stable at melt processing temperatures of extrusion and final shaping into the plastic article.

Of commercially available oils, Peneteck LT mineral oil from Calumet Penreco of Dallas, Tex. and PD-23 WHITE OIL from Sonneborn, Inc. of Tarrytown, N.Y. are acceptable plasticizer oils for this invention.

Optional Additives

The compound of the present invention can include conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; smoke suppresants; impact modifiers; initiators; lubricants; micas; pigments, colorants and dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

A preferred anti-oxidant is an Irganox brand pentaerythritol antioxidant identified as CAS 6683-19-8. A preferred processing stabilizer is an Irgafos brand trisarylphosphite processing stabiliser identified as CAS No. 31570-04-4

Table 1 shows the acceptable, desirable, and preferable ranges of ingredients for the low hardness TPE compound of the present invention.

TABLE 1
Ranges of Ingredients

| Ingredient | | | |
|---|---|---|---|
| (Wt. Percent) | Acceptable | Desirable | Preferable |
| SBC Copolymer | 9-15% | 9-13% | 9-10% |
| Plasticizer Oil | 85-91% | 87-91% | 90-91% |
| Anti-oxidant | 0-3% | 0-2% | 0-1% |
| Processing | 0-3% | 0-2% | 0-1% |
| Stabilizer | | | |
| Other Optional | 0-15% | 0-10% | 0-5% |
| Additives | | | |

Reshaping into Plastic Article

With pellets of TPE compound made via continuous extrusion processing, persons having ordinary skill in the art, without undue experimentation, can reshape the pellets into any conceivable plastic article which has a Shore OOO Hardness of less than about 60.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

Typical processes used to mold such soft TPE compounds include casting, rotational molding, slush molding, extrusion coating, injection molding, compression molding, transfer molding, dip molding. Such soft TPE compounds can also be over-molded or extruded onto rigid substrates. Such soft TPE compounds can also be melted in a melting tank and pumped as a liquid into molds.

The low hardness thermoplastic elastomer compounds of this invention commonly exhibit very low melt viscosity values which make them difficult to process into useable parts or articles using traditional injection molding machines. As a result, it has been found that parts and articles can be formed by using a hot melt adhesive dispensing unit and/or a hot melt adhesive drum unloading unit.

The low hardness thermoplastic elastomer compound can be placed in metal or fiber drums which can be loaded into a drum dispensing unit. Common manufacturers of such machines are Nordson Corporation (Westlake, Ohio) and ITW-Dynatec (Hendersonville, Tenn.) with DuraDrum® Bulk Melters and DynaDrum™—Bulk Adhesive Melters, respectively. The low hardness thermoplastic elastomer compound can be heated in stages starting at the bulk melter, along the dispensing hose, and finally at the heated dispensing nozzle. This process allows for accurate control of the temperature of the compound as well as control over the volume of material dispensed. The molten compound can be dispensed into open faced mold cavities or can be dispensed directly into closed mold cavities with sufficient venting to allow air to be displaced. Typical melting temperatures employed to dispense the compound range from about 120° C. to about 230° C., depending on the particular compound formulation.

### USEFULNESS OF THE INVENTION

Very soft TPE compound of the present invention has an excellent versatility as a molded or extruded TPE plastic article because of the massive presence of the plasticizer oil, which does not exude during use in temperatures between about 40° F. and 110° F.

The addition of anti-oxidant properties and thermal stabilization, by those respective functional additives allows the TPE compound to have durable properties any plastic article should have.

The foamed TPE can be used in the molding or extruding or other shaping of plastic articles which benefits from the low density, low hardness, high durability, and elastomer properties of a fully thermoplastic material.

Markets or industries into which the very soft TPE compound can be introduced include appliances (refrigerators, freezers, washers, dryers, toasters, blenders, vacuum cleaners, coffee makers, and mixers); building and construction industries (pipes and fittings, trim, and molding); consumer goods (power hand tools, rakes, shovels, lawn mowers, shoes, boots, golf clubs, fishing poles, and watercraft); electrical/electronic products (printers, computers, business equipment, LCD projectors, mobile phones, connectors, chip trays, circuit breakers, and plugs); healthcare (wheelchairs, beds, testing equipment, analyzers, labware, ostomy goods, intra-venous sets, wound care, drug delivery, inhalers, and packaging); personal care products (toothbrushes, razors, combs, and hair brushes); industrial goods (containers, bottles, drums, material handling, gears, bearings, gaskets and seals, valves, and various safety equipment); packaging (food and beverage, cosmetic, detergents and cleaners, personal care, pharmaceutical and wellness); transportation (automotive aftermarket parts, window seals, and interior compartment parts); and wire and cable (cars and trucks, airplanes, aerospace, construction, military, telecommunication, utility power, alternative energy, and electronics). Of these various possibilities, TPE compounds are particularly suitable for shoe in-soles, toe separators, novelties and toys, cushions, ergonomic mats of all types.

### EXAMPLES

Table 2 shows sources of ingredients used in the Examples 1-13 and Comparative Examples A-M. Table 3 highlights the molecular weight for each SBC polymer and each plasticizer oil used in the Examples and Comparative Examples. Tables 4-8 show the formulations, the mixing conditions, and the resulting properties measured, if possible, for the Examples and Comparative Examples.

To the extent possible, the Examples and Comparative Examples were mixed in a Henschel mixer in the conditions shown and then monitored for at least 24 hours to determine whether the oil was absorbed into the TPE crumb. If the crumb remained “wet” and could not be fed into an extruder, then that experiment became a Comparative Example, and those which could be fed with cramming proceeded as the Examples.

A co-rotating twin-screw extruder was used with conditions shown, resulting in very homogeneous melt which was pelletized with a GALA underwater pelletizer die of 0.5 inch length and 0.093 inch diameter. The pellets were then dusted with 1500 ppm of calcium stearate partitioning agent for storage before use.

Brookfield Viscosity and Shore A hardness tests were performed on the pellets reshaped into a 2 inch diameter, 0.5 inch thick disc formed by casting the pellets into that shape using a aluminum pan and heating the pellets at 250° F. on a hot plate.

TABLE 2

| Ingredient | | | Commercial |
|---|---|---|---|
| Name | Purpose | Generic Name | Source |
| G-1651HU | TPE | Styrene Ethylene Butylene | Kraton Polymers |
| | | Styrene Copolymer (SEBS) | (Houston) |
| G-1654H | TPE | SEBS | Kraton Polymers |
| G-1650 | TPE | SEBS | Kraton Polymers |
| Septon | TPE | SEBS | Kuraray America |
| 8006 | | | Inc. (Houston) |
| Septon | TPE | Styrene Ethylene Ethylene | Kuraray America |
| 4033 | | Propylene Styrene | Inc. |
| | | Coplymer (SEEPS) | |
| Septon | TPE | SEEPS | Kuraray America |
| 4055 | | | Inc. |
| Septon | TPE | SEEPS | Kuraray America |
| 4077 | | | Inc. |
| Septon | TPE | Styrene Ethylene Propylene | Kuraray America |
| 2005 | | Styrene Copolymer (SEPS) | Inc. |
| Vector | TPE | Styrene Butadiene Styene | Dexco Polymers |
| 2518 | | Copolymer (SBS) | (Philadelphia) |
| PD-23 | Plasticizer | Petroleum Distillate | Sonneborn, Inc. |
| WHITE | | | (Tarrytown, NY) |
| OIL | | | |
| Peneteck | Plasticizer | White Mineral Oil/ | Calumet Penreco |
| LT MIN | | Paraffinic Oil | (Dallas) |
| OIL NF | | | |
| Puretol 10 | Plasticizer | White Mineral Oil/ | Petro-Canada |
| (100) | | Paraffinic Oil | (Toronto) |
| PURETOL | Plasticizer | White Mineral Oil/ | Petro-Canada |
| PSO 380 | | Paraffinic Oil | |
| Drakeol | Plasticizer | White Mineral Oil/ | Calumet Penreco |
| Supreme | | Paraffinic Oil | |
| 600 | | | |
| Irganox | Antioxidant | Tetrakis[methylene (3,5-di- | BASF (fka Ciba); |
| 1010 | | tert-butyl-4-hydroxy-hydro- | Chidley & Peto |
| | | cinnamate)] methane | (Distributor), Carol |
| | | | Stream, Illinois |
| Irgafos | Antioxidant | Tris (2,4-di(tert)- | BASF (fka Ciba); |
| 168 | | butylphenyl) phosphite | Chidley & Peto |
| | | | (Distributor) |

TABLE 3
Ingredient Properties
TPE Properties

| | | Molecular | | | Apparent |
|---|---|---|---|---|---|
| | | Wt. (M_{w}) | % Styrene | Product | Porosity* |
| Polymer | Type | (approx.) | Content | Form | (sec.) |
| Kraton G1651HU | SEBS | 280,000 | 33 | Porous | 380-550 |
| | | | | Crumb | |
| Kraton G1650 | SEBS | 105,000 | 30 | Porous | NM |
| | | | | Crumb | |
| Kraton G1654H | SEBS | 200,000 | 31 | Porous | NM |
| | | | | Crumb | |
| Septon 8006 | SEBS | 310,000 | 33 | Porous | >900 |
| | | | | Crumb | |
| Septon 4033 | SEEPS | 95,000 | 30 | Porous | NM |
| | | | | Crumb | |
| Septon 4055 | SEEPS | 310,000 | 30 | Porous | NM |
| | | | | Crumb | |
| Septon 4077 | SEEPS | 390,000 | 30 | Porous | NM |
| | | | | Crumb | |
| Septon 2005 | SEPS | 335,000 | 20 | Porous | NM |
| | | | | Crumb | |
| Vector 2518 | SBS | 165,000 | 31 | Porous | NM |
| | | | | Pellet | |

Plasticizer Oil Properties

| | | Viscosity, SUS @ | |
|---|---|---|---|
| | M_{w} (approx.) | 100° F. (approx.) | Flash Point, ° F. |
| PD-23 | 200 | 35 | 225 |
| Peneteck LT MIN | 250 | 40 | 265 |
| OIL NF | | | |
| Puretol 10 | 400 | 100 | 370 |
| PURETOL PSO 380 | 600 | 370 | 485 |
| Drakeol Supreme 600 | 750 | 550 | 505 |

*Apparent Porosity is Oil Absorption Time measured by oil absorption in a Brabender mixer set at 50° C. and rotating at 60 rpm using a ratio of 10 parts of porous crumb TPE, 25 parts of 380 visc viscosity oil (M_{w} ≈ 500), and 3 parts of calcium carbonate filler (particle size = 5-15 μm). The crumb and filler were mixed for one minute before the oil was added. Change in torque of the mixer was monitored, and the time in seconds when that change occurred was recorded as the time of apparent oil absorption.

TABLE 4

| | | | | |
|---|---|---|---|---|
| Example | A | B | C | 1 |

Formulations (Wt. %)

| | | | | |
|---|---|---|---|---|
| Kraton G-1651 | 14.3 | 14.3 | 14.3 | 14.3 |
| Puretol 10 | 85.7 | | | |
| PURETOL PSO 380 | | 85.7 | | |
| Drakeol Supreme 600 | | | 85.7 | |
| Peneteck LT MIN OIL NF | | | | 85.7 |

Henschel Mixing Observations

| | | | | |
|---|---|---|---|---|
| Mix Speed | High | High | High | High |
| Mix time, min | 7 | 7 | 7 | 5 |
| Mix Temp, ° F. | 139 | 140 | 140 | 125 |

Oiled Crumb Condition

| | | | | |
|---|---|---|---|---|
| Oiled Crumb after mixing | Very wet | Very wet | Very wet | Dry with some free |
| | | | | oil |
| Oiled Crumb after 24 hrs | Still wet | Very wet | Very wet | Dry with some free |
| | | | | oil |

Compounding

| | | | | |
|---|---|---|---|---|
| Feedability | Not possible | Not possible | Not possible | Feedable with |
| | | | | cramming |
| Zones and Temperatures | Not applicable | N/A | N/A | 250° F. in all zones |
| | (N/A) | | | |
| Mixing Speed/Run Rate, | N/A | N/A | N/A | 450 rpm/40 lbs/hr |
| lbs/hr | | | | |
| Die Geometry | N/A | N/A | N/A | 4 holes, 0.093 inch |
| | | | | diameter |
| Mixture Homogenity | N/A | N/A | N/A | Very Well Mixed |
| Pelletization/Pellet | N/A | N/A | N/A | Good |
| Appearance | | | | |

Properties

| | | | | |
|---|---|---|---|---|
| M_{w} of TPE | 280,000 | 280,000 | 280,000 | 280,000 |
| M_{w} of Plasticizer Oil | 400 | 600 | 750 | 250 |
| Hardness, Shore OO, 10 s | NM | NM | NM | 11 |
| delay (ASTM D2240) | | | | |
| Hardness, Shore OOO, 10 s | NM | NM | NM | 59 |
| delay (ASTM D2240) | | | | |
| Brookfield Viscosity @ | NM | NM | NM | 3998 |
| 350° F., Spindle # 27, | | | | |
| centipoise (ASTM D3236) | | | | |

TABLE 5

| | | | | | | | | | |
|---|---|---|---|---|---|---|---|---|---|
| Example | 2 | D | 3 | E | F | 4 | G | H | I |

Formulations (Wt. %)

| | | | | | | | | | |
|---|---|---|---|---|---|---|---|---|---|
| Kraton G-1651 | 12.5 | | | | | | | | |
| Kraton G-1650 | | 12.5 | | | | | | | |
| Kraton G-1654 | | | 12.5 | | | | | | |
| Septon 4033 | | | | 12.5 | | | | | |
| Septon 4055 | | | | | 12.5 | | | | |
| Septon 4077 | | | | | | 12.5 | | | |
| Vector 2518 | | | | | | | 12.5 | | |
| Septon 8006 | | | | | | | | 12.5 | |
| Septon 2005 | | | | | | | | | 12.5 |
| Peneteck LT | 87.5 | 87.5 | 87.5 | 87.5 | 87.5 | 87.5 | 87.5 | 87.5 | 87.5 |
| MIN OIL NF | | | | | | | | | |

Henschel Mixing Conditions

| | | | | | | | | | |
|---|---|---|---|---|---|---|---|---|---|
| Mix Speed | High | High | High | High | High | High | High | High | High |
| Mix time, min | 9 | 7 | 7 | 4 | 5 | 5 | 5 | 15 | 5 |
| Mix Temp, ° F. | 120 | 110 | 110 | 100 | 110 | 110 | N/A | 120 | 105 |

Oiled Crumb Conditions

| | | | | | | | | | |
|---|---|---|---|---|---|---|---|---|---|
| Oiled Crumb | Dry with | Fused | Dry with | Fused | Very wet | Dry with | Oil & | Extremely | Extremely |
| after mixing | some free | immediately | some free | immediately | | some free | pellets | wet | wet |
| | oil | | oil | | | oil | separate | | |
| Oiled Crumb | More dry | N/A | More dry | N/A | Still very | More dry | N/A | Extremely | Extremely |
| after 24 hrs | with some | | with some | | wet | with some | | wet | wet |
| | free oil | | free oil | | | free oil | | | |

Compounding

| | | | | | | | | | |
|---|---|---|---|---|---|---|---|---|---|
| Feedability | Feedable | Not | Feedable | Not | Not | Feedable | Not | Not | Not |
| | with | possible | with | possible | possible | with | possible | possible | possible |
| | cramming | | cramming | | | cramming | | | |
| Zones and | 250° F. all | N/A | 250° F. all | N/A | N/A | 250° F. all | N/A | N/A | N/A |
| Temperatures | across | | across | | | across | | | |
| Mixing Speed/ | 450 rpm/25 | N/A | 450 rpm/25 | N/A | N/A | 450 rpm/25 | N/A | N/A | N/A |
| Run Rate, lbs/hr | | | | | | | | | |
| Die Geometry | 4 holes, | | 4 holes, | | | 4 holes, | | | |
| | 0.093 inch | | 0.093 inch | | | 0.093 inch | | | |
| | dia | | dia | | | dia | | | |
| Mixture | Good | N/A | Good | N/A | N/A | Good | N/A | N/A | N/A |
| Homogenity | | | | | | | | | |
| Pelletization/ | Good | N/A | Good | N/A | N/A | Good | N/A | N/A | N/A |
| Pellet Appearance | | | | | | | | | |

Properties

| | | | | | | | | | |
|---|---|---|---|---|---|---|---|---|---|
| M_{W} of TPE | 280,000 | 105,000 | 204,000 | 95,000 | 310,000 | 390,000 | 165,000 | 310,000 | 335,000 |
| M_{W} of Plasticizer | 250 | 250 | 250 | 250 | 250 | 250 | 250 | 250 | 250 |
| Oil | | | | | | | | | |
| Hardness, Shore | 6 | NM | 12 | 11 | NM | <0 | NM | NM | NM |
| OO, 10 s delay | | | | | | | | | |
| (ASTM D2240) | | | | | | | | | |
| Hardness, Shore | 55 | NM | 58 | NM | NM | 52 | NM | NM | NM |
| OOO, 10 s delay | | | | | | | | | |
| (ASTM D2240) | | | | | | | | | |
| Brookfield | 3998 | NM | 550 | NM | NM | 17,879 | NM | NM | NM |
| Viscosity @ | | | | | | | | | |
| 350° F., Spindle | | | | | | | | | |
| #27, centipoise | | | | | | | | | |
| (ASTM D3236) | | | | | | | | | |

TABLE 6

| | | | | | | | |
|---|---|---|---|---|---|---|---|
| Example | J | K | 5 | 6 | 7 | 8 | 9 |

Formulations (Wt. %)

| | | | | | | | |
|---|---|---|---|---|---|---|---|
| Kraton G-1651 | 10 | | 13.71 | 12.43 | 11.36 | 13.71 | 11.36 |
| Septon 4077 | | 10 | | | | | |
| Irganox 1010 | | | 0.25 | 0.25 | 0.25 | 0.25 | 0.25 |
| Irgafos 168 | | | 0.34 | 0.34 | 0.34 | 0.34 | 0.34 |
| Peneteck LT | 90 | 90 | | | | 85.7 | 88.05 |
| MIN OIL NF | | | | | | | |
| PD-23 WHITE OIL | | | 85.7 | 86.99 | 88.05 | | |

Henschel Mixing Observations

| | | | | | | | |
|---|---|---|---|---|---|---|---|
| Mix Speed | High | High | High | High | High | High | High |
| Mix time, min | 15 | 15 | 9 | 9 | 9 | 9 | 9 |
| Mix Temp, ° F. | 120 | 120 | 120 | 120 | 120 | 120 | 120 |

Oiled Crumb Condition

| | | | | | | | |
|---|---|---|---|---|---|---|---|
| Oiled Crumb | Extremely | Extremely | Dry with | Dry with | Dry with | Dry with | Dry with |
| after mixing | wet | wet | some free | some free | some free | some free | some free |
| | | | oil | oil | oil | oil | oil |
| Oiled Crumb | Extremely | Extremely | More dry | More dry | More dry | More dry | More dry |
| after 24 hrs | wet | wet | with some | with some | with some | with some | with some |
| | | | free oil | free oil | free oil | free oil | free oil |

Compounding

| | | | | | | | |
|---|---|---|---|---|---|---|---|
| Feedability | Not | Not | Feedable | Feedable | Feedable | Feedable | Feedable |
| | possible | possible | with | with | with | with | with |
| | | | cramming | cramming | cramming | cramming | cramming |
| Zones and | N/A | N/A | 250° F. all | 250° F. all | 250° F. all | 250° F. all | 250° F. all |
| Temperatures | | | across | across | across | across | across |
| Mixing Speed/ | N/A | N/A | 450 rpm/25 | 450 rpm/25 | 450 rpm/25 | 450 rpm/25 | 450 rpm/25 |
| Run Rate, lbs/hr | | | | | | | |
| Die Geometry | N/A | N/A | 4 holes, | 4 holes, | 4 holes, | 4 holes, | 4 holes, |
| | | | 0.093″ dia | 0.093″ dia | 0.093″ dia | 0.093″ dia | 0.093″ dia |
| Mixture | N/A | N/A | Good | Good | Good | Good | Good |
| Homogenity | | | | | | | |
| Pelletization/ | N/A | N/A | Good | Good | Good | Good | Good |
| Pellet Appearance | | | | | | | |

Properties

| | | | | | | | |
|---|---|---|---|---|---|---|---|
| M_{W} of TPE | 280,000 | 390,000 | 280,000 | 280,000 | 280,000 | 280,000 | 280,000 |
| M_{W} of Plasticizer | 250 | 250 | 250 | 250 | 250 | 250 | 250 |
| Oil | | | | | | | |
| Hardness, Shore | NM | NM | 12 | 0 | 0 | 11 | 0 |
| OO, 10 s delay | | | | | | | |
| (ASTM D2240) | | | | | | | |
| Hardness, Shore | NM | NM | NM | NM | NM | 52 | 49 |
| OOO, 10 s delay | | | | | | | |
| (ASTM D2240) | | | | | | | |
| Brookfield | NM | NM | 270 | 110 | 35 | 650 | 140 |
| Viscosity @ | | | | | | | |
| 350° F., Spindle | | | | | | | |
| #27, centipoises | | | | | | | |
| (ASTM D3236) | | | | | | | |

TABLE 7

| | | | |
|---|---|---|---|
| Example | L | M | 10 |

Formulations (Wt. %)

| | | | |
|---|---|---|---|
| Kraton G-1651 | 11.88 | 11.25 | 6.25 |
| Kraton G-1650 | 0.63 | 1.25 | |
| Kraton G-1654 | | | 6.25 |
| Peneteck LT MIN OIL NF | 87.5 | 87.5 | 87.5 |

Henschel Mixing Observations

| | | | |
|---|---|---|---|
| Mix Speed | High | High | High |
| Mix time, min | 9 | 7 | 4 |
| Mix Temp, ° F. | 120 | 110 | 100 |

Oiled Crumb Conditions

| | | | |
|---|---|---|---|
| Oiled Crumb after mixing | Fused | Fused | Dry with some |
| | | | free oil |
| Oiled Crumb after 24 hrs | Fused | Fused | Dry with some |
| | | | free oil |

Compounding

| | | | |
|---|---|---|---|
| Feedability | Not possible | Not possible | Feedable with |
| | | | cramming |
| Zones and Temperatures | N/A | N/A | 250° F. all across |
| Mixing Speed/Run Rate, | N/A | N/A | 450 rpm/25 |
| lbs/hr | | | |
| Die Geometry | N/A | N/A | 4 holes, |
| | | | 0.093” dia |
| Mixture Homogenity | N/A | N/A | Good |
| Pelletization / Pellet | N/A | N/A | Good |
| Appearance | | | |

Properties

| | | | |
|---|---|---|---|
| M_{w} of TPE (weighted | 271,180 | 262,500 | 240,000 |
| average) | | | |
| M_{w} of Plasticizer Oil | 250 | 250 | 250 |
| Hardness, Shore OOO | NM | NM | NM |
| (ASTM D2240) | | | |
| Brookfield Viscosity @ | NM | NM | NM |
| 350° F., Spindle # 27 , | | | |
| centipoise (ASTM D3236) | | | |

TABLE 8

| | | | |
|---|---|---|---|
| Examples | 11 | 12 | 13 |

Formulations (Wt. %)

| | | | |
|---|---|---|---|
| Kraton G-1651 | 11.11 | 10 | 9.09 |
| Peneteck LT MIN OIL NF | 77.78 | 70 | 63.64 |
| Peneteck LT MIN OIL NF | 11.11 | 20 | 27.27 |
| (injected after the first | | | |
| mixing zone) | | | |

Henschel Mixing Observations

| | | | |
|---|---|---|---|
| Mix Speed | High | High | High |
| Mix time, min | 9 | 9 | 9 |
| Mix Temp, ° F. | 120 | 120 | 120 |

Oiled Crumb Condition

| | | | |
|---|---|---|---|
| Oiled Crumb after mixing | Dry with | Dry with | Dry with |
| | some free | some free | some free |
| | oil | oil | oil |
| Oiled Crumb after 24 hrs | Dry with | Dry with | Dry with |
| | some free | some free | some free |
| | oil | oil | oil |

Compounding

| | | | |
|---|---|---|---|
| Feedability | Feedable | Feedable | Feedable |
| | with | with | with |
| | cramming | cramming | cramming |
| Zones and Temperatures | 250° F. all | 250° F. all | 250° F. all |
| | across | across | across |
| Mixing Speed/Run Rate, | 450 rpm/ | 450 rpm/ | 450 rpm/ |
| lbs/hr | 25 | 25 | 25 |
| Die Geometry | 4 holes, | 4 holes, | 4 holes, |
| | 0.093” dia | 0.093” dia | 0.093” dia |
| Mixture Homogenity | Good | Good | Good |
| Pelletization/Pellet | Good | Good | Good |
| Appearance | | | |

Properties

| | | | |
|---|---|---|---|
| M_{w} of TPE | 280,000 | 280,000 | 280,000 |
| M_{w} of Plasticizer Oil | 250 | 250 | 250 |
| Hardness, Shore OO, 10 s | 6 | 0 | 0 |
| delay (ASTM D2240) | | | |
| Hardness, Shore OOO, 10 s | 51 | 50 | 47 |
| delay (ASTM D2240) | | | |
| Brookfield Viscosity @ | 465 | 267 | 169 |
| 350° F., Spindle # 27 , | | | |
| centipoise (ASTM D3236) | | | |

Referring to Table 4, Comparative Examples A-C and Example 1 demonstrate that the viscosity for the plasticizer oil must be less than 100 centipoise and the M_{w} less than 400.

Referring to Table 5, Comparative Examples D, E, and G and Example 3 demonstrate that the M_{w} of the TPE must be greater than 200,000. Comparative Example H and Example 2 demonstrate that the Apparent Porosity and Oil Absorption Time of the TPE crumb must be less than 900 sec. and preferably less than 600 sec. Comparative Example I and Examples 2 and 4 demonstrate that suitable TPEs include SEBS and SEEPS. Comparative Example F and Example 3 demonstrate that one must understand Apparent Porosity before selecting SEBS or SEEPS as the TPE.

Qualitatively, that Apparent Porosity can be determined by viewing the condition of the oiled crumb after mixing and after 24 hours. A person having ordinary skill in the art, without undue experimentation, can use the condition of the oiled crumb after 24 hours as an indication of whether the plasticizer oil of more than 85 wt. % has been absorbed sufficiently into the TPE crumb in order to perform compounding via twin-screw extrusion. The next qualitative observation moment for that person having ordinary skill in the art is whether the oiled crumb can be fed into the extruder. If not, then it is immediately apparent that the Apparent Porosity of the TPE crumb chosen is insufficient to absorb more than 85 wt. percent of plasticizer oil of a viscosity of less than 100 centipoise and a M_{w} of less than 400.

Referring to Table 6, Comparative Example J and Examples 5-9 demonstrate that plasticizer oil can only be loaded between 85 wt. % and 88 wt. % during mixing prior to compounding. The capacity of TPE crumb to absorb oil and still be able to perform compounding ends before 90 wt. %. Comparative Example K demonstrates that the upper limit oiling by mixing applies to both SEBS and SEEPS otherwise suitable in M_{w} for use in the invention.

Referring to Table 7, Comparative Examples L and M and Example 10 demonstrate that any amount of TPE with a M_{w} below 200,000 is detrimental to performance of the TPE in the invention, even if the average M_{w} is greater than 200,000.

Referring to Table 8, Examples 11-13 demonstrate that starting with a oiled crumb of 87.5 wt. % oil, one can add different amounts that same oil at the first zone of the extruder during compounding in order to move above the 88% maximum threshold and achieve as high as 91 wt. % oil.

The plasticized TPEs of the Examples result in hardnesses of 47, 49, 50, 51, 52, 55, 58, and 59 on the Shore OOO scale, demonstrating that a person having ordinary skill in the art without undue experimentation can tailor plasticized TPEs of the present invention to any particular Shore OOO hardness between about 45 and 60 Shore OOO scale for use in making plastic objects of super-soft feel.

The invention is not limited to the above embodiments. The claims follow.

What is claimed is:

1. A low hardness thermoplastic elastomer compound, comprising:
(a) a styrene-containing thermoplastic elastomer having a weight average molecular weight of greater than 200,000 and an oil absorption time of less than 900 seconds, and
(b) plasticizer oil having a weight average molecular weight of less than 400 absorbed into the styrene-containing thermoplastic elastomer in a weight percent of the compound ranging from 85 to 91.

2. The compound of claim 1, wherein the styrene-containing thermoplastic elastomer is selected from the group consisting of styrene-ethylene-butylene-styrene, styrene-ethylene-propylene-styrene, styrene-ethylene-ethylene/propylene-styrene, styrene-isobutylene-styrene, styrene-butadiene-styrene, styrene-isoprene-styrene, and combinations thereof.

3. The compound of claim 1 or claim 2, wherein the styrene-containing thermoplastic elastomer is styrene-ethylene-butylene-styrene or styrene-ethylene-ethylene/propylene-styrene.

4. The compound of claim 3, wherein the styrene-ethylene-butylene-styrene has a polystyrene content of between about 30 and 34, a specific gravity of about 0.9, and a Shore A hardness of between about 60 and 75.

5. The compound of any of claim 1, wherein the compound is in the form of a porous crumb with the plasticizer oil absorbed into pores of the crumb prior to melt mixing in an extruder, and wherein the weight percent of the plasticizer oil in the compound ranges from 85 to 88.

6. The compound of claim 1, wherein the compound is in the form of a pellet after melt mixing in an extruder.

7. The compound of claim 6, wherein the weight percent of the plasticizer oil in the compound ranges from 89 to 91 after additional plasticizer oil has been injected into the extruder after a first mixing zone.

8. The compound of claim 5, wherein the plasticizer oil is a white mineral oil.

9. The compound of claim 1, wherein the Shore OOO Hardness of the compound ranges from about 45 to about 60.

10. The compound of claim 1, further comprising adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; additional plasticizers; processing aids; release agents; silanes, titanates and zirconates; slip and anti-blocking agents; stabilizers; stearates; ultraviolet light absorbers; viscosity regulators; waxes; and combinations of them.

11. A thermoplastic article, comprising the compound of claim 1.

12. The article of claim 11, wherein the Shore OOO Hardness of the article ranges from about 45 to about 60.

13. The article of claim 11, wherein the article is molded.

14. The article of claim 11, wherein the article is extruded.

15. A method of molding the compound of claim 1, comprising the steps of:
(a) placing the compound into a drum dispensing unit;
(b) heating the compound a bulk melter;
(c) heating the compound along a dispensing hose;
(d) heating the compound at a dispensing nozzle; and
(e) dispensing the compound into a mold.

16. The method of claim 15, wherein the heating of steps (b), (c), and (d) occur at a temperature ranging from about 120° C. to about 230° C.

17. The method of claim 15, wherein the mold is an open faced mold cavity.

18. The method of claim 15, wherein the mold is a closed mold cavity with sufficient venting to allow air to be displaced.

19. A molded article prepared by the method of claim 15.

20. The article of claim 19, wherein the Shore OOO Hardness of the article ranges from about 45 to about 60.
